(19) United States
(12) Patent Application Publication
(10) Pub. No.: US 2025/0337278 A1
(43) Pub. Date: Oct. 30, 2025

(54) VEHICULAR CONTACTLESS CHARGING DEVICE

(71) Applicant: TOYODA GOSEI CO., LTD., Kiyosu-shi (JP)

(72) Inventors: Ryowa NIIMI, Kiyosu-shi (JP); Takao HORI, Kiyosu-shi (JP)

(21) Appl. No.: 19/169,524

(22) Filed: Apr. 3, 2025

(30) Foreign Application Priority Data
Apr. 26, 2024 (JP) 2024-072539

(51) Int. Cl. H02J 50/10; B60R 16/033

(52) U.S. Cl. CPC H02J 50/10; B60R 16/033

(57) ABSTRACT

A vehicular contactless charging device includes a power feeding coil and circuitry configured to supply power to the power feeding coil, and to stop the supply of power to the power feeding coil. The circuitry is configured to set the power feeding coil to a charging state when a device to be charged is brought close to the power feeding coil to reach a position enabling charging. The circuitry is also configured to set the power feeding coil to a standby state when the device to be charged moves away from the power feeding coil to be separated from the position enabling charging. The circuitry is further configured to change a frequency of the power when switching the power feeding coil from the standby state to the charging state after switching the power feeding coil from the charging state to the standby state.

### CROSS-REFERENCE TO RELATED APPLICATIONS

This application is based upon and claims the benefit of priority from Japanese Patent Application No. 2024-072539, filed on Apr. 26, 2024, the entire contents of which are incorporated herein by reference.

BACKGROUND

### 1. Field

The present disclosure relates to a vehicular contactless charging device.

### 2. Description of Related Art

In a typical vehicular contactless charging device, when a device to be charged is brought close to the power feeding coil to reach a position enabling charging, a voltage is induced in a power receiving coil of the device to be charged through power supply to the power feeding coil. As a result, the device to be charged receives power from the power receiving coil and is charged.

If a harmonic of the frequency of the power supplied to the power feeding coil of the vehicular contactless charging device is close to the frequency tuned on a vehicle- mounted radio, noise may be introduced into the radio broadcast. To address this issue, the above-described vehicular contactless charging device allows the frequency of the power to be supplied to the power feeding coil to be changed. If noise is introduced into the radio broadcast, the user adjusts the frequency of the power through an operation unit, such as a switch.

Since an operation unit such as a switch must be provided in the above-described vehicular contactless charging device, the size of the device is increased. Also, the number of components is increased.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a vehicular contactless charging device includes a power feeding coil and circuitry configured to supply power to the power feeding coil, and to stop the supply of power to the power feeding coil. The vehicular contactless charging device is configured such that, when a device to be charged is brought close to the power feeding coil to reach a position enabling charging, a voltage is induced in a power receiving coil of the device to be charged through the supply of power to the power feeding coil by the circuitry, so that the device to be charged receives power from the power receiving coil and is charged. The circuitry is configured to supply power to the power feeding coil to set the power feeding coil to a charging state when the device to be charged is brought close to the power feeding coil to reach the position enabling charging. Also, the circuitry is configured to stop the supply of power to the power feeding coil to set the power feeding coil to a standby state when the device to be charged moves away from the power feeding coil to be separated from the position enabling charging. Further, the circuitry is configured to change a frequency of the power to be supplied to the power feeding coil when switching the power feeding coil from the standby state to the charging state after switching the power feeding coil from the charging state to the standby state.

Other features and aspects will be apparent from the following detailed description, the drawings, and the claims.

### BRIEF DESCRIPTION OF THE DRAWINGS

FIG. 1 is a schematic diagram showing a configuration of a vehicular contactless charging device.

FIG. 2 is a flowchart showing a procedure for changing a frequency by the vehicular contactless charging device shown in FIG. 1.

FIG. 3 is a flowchart showing the procedure for changing a frequency by the vehicular contactless charging device shown in FIG. 1.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art. In this specification, “at least one of A and B” should be understood to mean “only A, only B, or both A and B.”

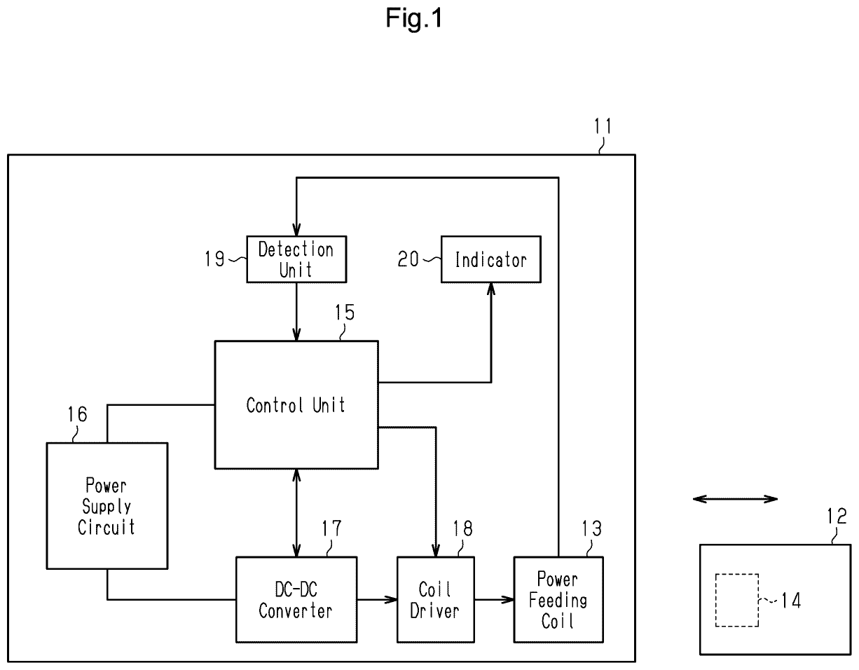

A vehicular contactless charging device 11 according to an embodiment will now be described with reference to FIGS. 1 to 3.

The vehicular contactless charging device 11 illustrated in FIG. 1 charges a device to be charged 12, such as a smartphone in a passenger compartment. The vehicular contactless charging device 11 includes a power feeding coil 13 used for charging the device to be charged 12, and a control unit 15 for supplying and stopping power to the power feeding coil 13. In the vehicular contactless charging device 11, when the device to be charged 12 is brought close to the power feeding coil 13 to reach a position enabling charging, a voltage is induced in a power receiving coil 14 of the device to be charged 12 through power supply to the power feeding coil 13 by the control unit 15. As a result, the device to be charged 12 receives power from the power receiving coil 14 and is charged.

The vehicular contactless charging device 11 includes a power supply circuit 16, a DC-DC converter 17, a coil driver 18, a detection unit 19, and an indicator 20. The control unit 15 includes, for example, a microcomputer. The control unit 15 may be circuitry including: 1) one or more processors that operate according to a computer program (software); 2) one or more dedicated hardware circuits (application specific integrated circuits: ASIC) that execute at least part of various processes; or 3) a combination thereof. The processor includes a CPU and memory modules such as RAM and ROM. The memory modules store program codes or commands configured to cause the CPU to execute processes. The memory modules, or computer-readable media, include any type of media that are accessible by general-purpose computers and dedicated computers. The control unit 15 controls various devices such as the DC-DC converter 17, the coil driver 18, and the indicator 20 in the vehicular contactless charging device 11. The power supply circuit 16 receives power supply from a battery mounted on the vehicle, and supplies power to various devices such as the control unit 15 in the vehicular contactless charging device 11.

The DC-DC converter 17 and the coil driver 18 are configured to supply power from the power supply circuit 16 to the power feeding coil 13. The DC-DC converter 17 is configured to increase or decrease the voltage when power is supplied to the power feeding coil 13. The coil driver 18 is configured to supply power to the power feeding coil 13. The control unit 15 is capable of supplying power to the power feeding coil 13 and stopping the supply of power through control of the coil driver 18. Further, the control unit 15 is capable of changing the frequency of the power supplied to the power feeding coil 13 through control of the coil driver 18.

When the device to be charged 12 approaches the power feeding coil 13 to reach the position enabling charging, the characteristics of the power feeding coil 13 change. Based on such a change in the characteristics, the detection unit 19 outputs, to the control unit 15, a signal corresponding to the approach of the device to be charged 12. The control unit 15 supplies power to the power feeding coil 13 by controlling the coil driver 18 based on the signal from the detection unit 19. As a result, the control unit 15 sets the power feeding coil 13 to a charging state. When power is supplied to the power feeding coil 13 in this manner, a voltage is induced in the power receiving coil 14 of the device to be charged 12. As a result, the device to be charged 12 is supplied with power from the power receiving coil 14 and is charged.

When the device to be charged 12 is separated from the position enabling charging, the characteristics of the power feeding coil 13 change. Based on such a change in the characteristics, the detection unit 19 outputs, to the control unit 15, a signal corresponding to the separation from the position enabling charging. While the device to be charged 12 remains separated from the position enabling charging, the detection unit 19 continuously outputs, to the control unit 15, the signal corresponding to the separation from the position enabling charging. The control unit 15 stops the supply of power to the power feeding coil 13 by controlling the coil driver 18 based on the signal from the detection unit 19. As a result, the control unit 15 sets the power feeding coil 13 to a standby state. When the supply of power to the power feeding coil 13 is stopped in this manner, charging of the device to be charged 12 is stopped.

The indicator 20 is capable of notifying the user of whether the device to be charged 12 is in a charging state or a standby state under the vehicular contactless charging device 11 by being illuminated in a color corresponding to each state. Specifically, the control unit 15 of the vehicular contactless charging device 11 illuminates the indicator 20 in a color associated with the charging state, or in a color associated with the standby state, depending on whether the power feeding coil 13 is in the charging state or the standby state.

### Changing the Frequency of Power to be Supplied to the Power Feeding Coil 13

If a harmonic of the frequency of the power to be supplied to the power feeding coil 13 of the vehicular contactless charging device 11 is close to the frequency tuned on a vehicle-mounted radio, noise may be introduced into the radio broadcast. To address this issue, the vehicular contactless charging device 11 is configured such that when the user initiates a change in the frequency of the power supplied to the power feeding coil 13, the control unit 15 changes the frequency accordingly.

Specifically, when noise is introduced into the radio broadcast, the user moves the device to be charged 12 away from the power feeding coil 13 and then brings the device to be charged 12 back toward the power feeding coil 13. In this case, the control unit 15 switches the power feeding coil 13 from the standby state to the charging state after switching the power feeding coil 13 from the charging state to the standby state. When the control unit 15 switches the power feeding coil 13 from the standby state to the charging state after switching the power feeding coil 13 from the charging state to the standby state as described above, the control unit 15 determines that the user has initiated the frequency change. The control unit 15 changes the frequency of the power to be supplied to the power feeding coil 13 based on such a determination.

The frequency is changed, for example, as follows. The control unit 15 is capable of switching the frequency of power to be supplied to the power feeding coil 13 between a first frequency f1 and a second frequency f2. The first frequency f1 is set to, for example, 127.7 kHz, and the second frequency f2 is set to, for example, 120.5 kHz.

When switching the power feeding coil 13 from the standby state to the charging state after switching the power feeding coil 13 from the charging state to the standby state, the control unit 15 changes the frequency as follows. When the frequency of the power to be supplied to the power feeding coil 13 is the first frequency f1, the control unit 15 switches the frequency to the second frequency f2. When the frequency of the power to be supplied to the power feeding coil 13 is the second frequency f2, the control unit 15 switches the frequency to the first frequency f1.

### Operation of the Vehicular Contactless Charging Device 11

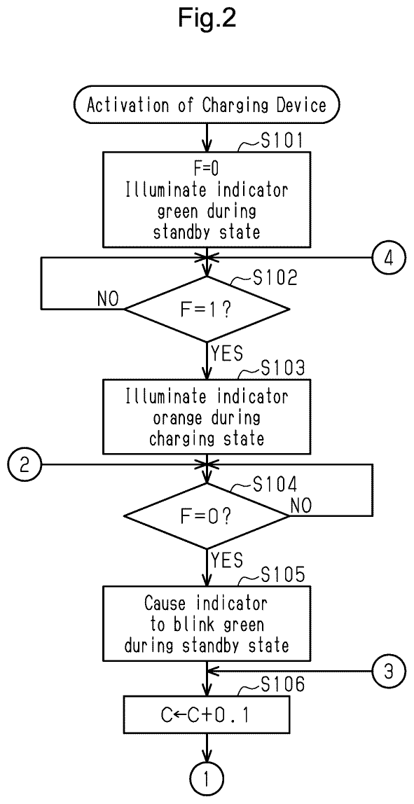

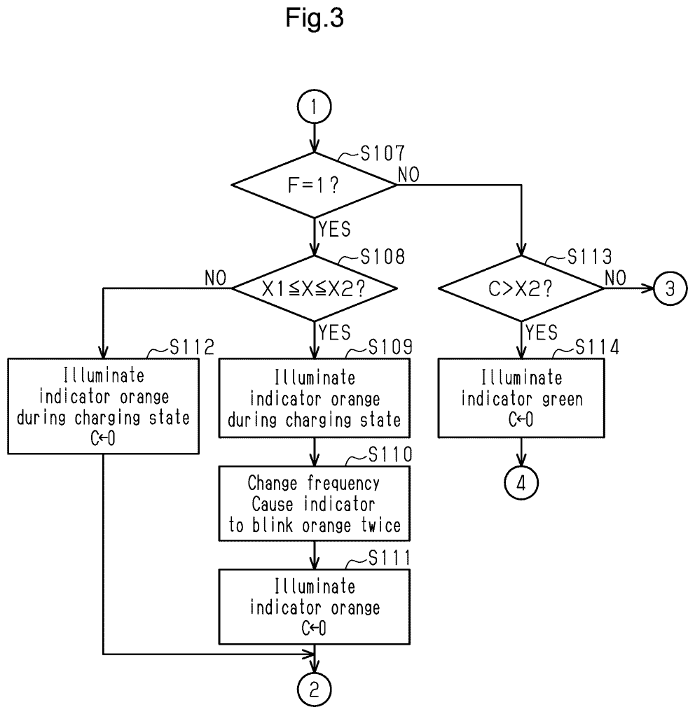

FIGS. 2 and 3 are flowcharts showing a procedure for changing the frequency of the power to be supplied to the power feeding coil 13. The process shown in this flowchart is started when the vehicular contactless charging device 11 is activated by turning on the power supply.

After the activation of the vehicular contactless charging device 11, the control unit 15 sets a flag F for determining whether the device to be charged 12 has approached the power feeding coil 13 to reach the position enabling charging to an initial value of 0, as part of the process of step 101 (S101) of FIG. 2. Furthermore, as part of the process of S101, the control unit 15 stops the supply of power to the power feeding coil 13 so that the power feeding coil 13 is in the standby state. In addition, as part of the process of S101, the control unit 15 illuminates the indicator 20 in a color corresponding to the power feeding coil 13 being in the standby state, for example, green, in order to notify the user that the power feeding coil 13 is in the standby state.

After the flag F is set to 0 in S101 as described above, the flag F is set as follows depending on whether the device to be charged 12 has approached the power feeding coil 13 to reach the position enabling charging. Specifically, the flag F is set to 1 when the device to be charged 12 has approached the power feeding coil 13 to reach the position enabling charging, and is set to 0 when the device to be charged 12 is away from the power feeding coil 13 and separated from the position enabling charging. After the execution of step S101, the process is advanced to step S102.

The control unit 15 determines whether the flag F is 1 as part of the process of S102. In a case in which the device to be charged 12 has not been brought close to the power feeding coil 13 to reach the position enabling charging, the flag F is set to 0, and thus the control unit 15 determines that the flag is 0 in S102. In this case, the process of S102 is repeatedly executed. When the device to be charged 12 is brought close to the power feeding coil 13 to reach the position enabling charging, the flag F is set to 1, and thus the control unit 15 determines that the flag F is 1 in S102. In this case, the process is advanced to S103.

As part of the process of S103, the control unit 15 supplies power to the power feeding coil 13 to set the power feeding coil 13 to the charging state. In addition, in order to notify the user that the power feeding coil 13 is in the charging state, the control unit 15 illuminates the indicator 20 in a color corresponding to the power feeding coil 13 being in the charging state, for example, orange, as part of the process of S103. Subsequently, the process is advanced to step S104.

The control unit 15 determines whether the flag F is 0 as part of the process of S104. In a case in which the device to be charged 12 remains close to the power feeding coil 13 and at the position enabling charging, the flag F is set to 1, and thus the control unit 15 determines that the flag F is 1 in S102. In this case, the process of S104 is repeatedly executed. When the device to be charged 12 is moved away from the power feeding coil 13 to be separated from the position enabling charging, the flag F is set to 0, and thus the control unit 15 determines that the flag F is 0 in S104. In this case, the process is advanced to S105.

As part of the process of S105, the control unit 15 stops the supply of power to the power feeding coil 13 so that the power feeding coil 13 is in the standby state. In addition, as part of the process of the S105, the control unit 15 causes the indicator 20 to blink, for example, green in order to notify the user that the power feeding coil 13 has been switched from the charging state to the standby state. Subsequently, the process is advanced to step S106.

The control unit 15 executes a counting process for a counter C as part of the process of S106. In this counting process, the value of the counter C is incremented by 0.1 each time a specified time elapses. The counter C is used to measure the elapsed time from a point in time at which the control unit 15 switches the power feeding coil 13 from the charging state to the standby state. Subsequently, as part of the process of S107 in FIG. 3, the control unit 15 determines whether the flag F is 1, in other words, whether the control unit 15 has switched the power feeding coil 13 from the standby state to the charging state after switching the power feeding coil 13 from the charging state to the standby state. When it is determined in S107 that the flag F is 1, that is, when it is determined that the control unit 15 has switched the power feeding coil 13 from the standby state to the charging state after switching the power feeding coil 13 from the charging state to the standby state, the process is advanced to S108.

As part of the process of S108, the control unit 15 determines whether the value of the counter C is within a specified range, that is, a range of X1 to X2. Determination in S108 that the value of the counter C is within the specified range, that is, the range of X1 to X2, indicates that an elapsed time t from the point in time at which the power feeding coil 13 is switched from the charging state to the standby state to the point in time at which the power feeding coil 13 is switched to the charging state again is within a predetermined time range. In other words, the range of X1 to X2 is set to correspond to such an elapsed time condition. The time range may be, for example, 0.5 seconds to 5 seconds, inclusive. If it is determined in S108 that the value of the counter C is within the range of X1 to X2, the process is advanced to S109.

When the process is advanced to S109, the control unit 15 determines that the user has initiated a change in the frequency of the power to be supplied to the power feeding coil 13. As part of the process of S109, the control unit 15 supplies power to the power feeding coil 13 to set the power feeding coil 13 to the charging state. In addition, in order to notify the user that the power feeding coil 13 is in the charging state, the control unit 15 illuminates the indicator 20 orange, as part of the process of S109. Subsequently, the process is advanced to step S110. The control unit 15 changes the frequency of the power to be supplied to the power feeding coil 13 as part of the process of S110. Furthermore, as part of the process of S110, the control unit 15 notifies the user that the frequency of the power to be supplied to the power feeding coil 13 has been changed by causing the indicator 20 to blink orange a specified number of times, for example, twice. Subsequently, the process is advanced to step S111.

In order to notify the user that the power feeding coil 13 is in the charging state, the control unit 15 illuminates the indicator 20 orange, as part of the process of S111. The control unit 15 resets the value of the counter C to 0, which is an initial value, as part of the process of S111. Thereafter, the process returns to S104 in FIG. 2.

In S107 of FIG. 3, in a case in which it is determined that the flag F is 0, that is, in a case in which it is determined that the power feeding coil 13 remains in the standby state after the control unit 15 switches the power feeding coil 13 from the charging state to the standby state, the process is advanced to S113. As part of the process of S113, the control unit 15 determines whether the value of the counter C is greater than the value X2 of the specified range of X1 to X2. If it is determined in S113 that the value of the counter C is less than the value X2, the process returns to S106 in FIG. 2.

When it is determined in S113 of FIG. 3 that the value of the counter C is greater than the value X2, in other words, when it is determined that the time from the point in time at which the control unit 15 switches the power feeding coil 13 from the charging state to the standby state is out of the above-described time range, the process is advanced to S114. Proceeding to the S114 indicates that the device to be charged 12, which was moved away from the power feeding coil 13, has not approached the power feeding coil 13.

In order to notify the user that the power feeding coil 13 is in the standby state, the control unit 15 illuminates the indicator 20 green, as part of the process of S114.

Furthermore, the control unit 15 resets the value of the counter C to 0, which is an initial value, as part of the process of S114. Thereafter, the process returns to S102 in FIG. 2.

It is determined in S108 of FIG. 3 that the value of the counter C is not in the specified range of X1 to X2 when the value of the counter C is less than the value X1 in the specified range of X1 to X2. In this case, the process is advanced to S112. Proceeding to the S112 indicates that the elapsed time t from the point in time at which the power feeding coil 13 is switched from the charging state to the standby state to the point in time at which the power feeding coil 13 is switched to the charging state again is not within the time range. As part of the process of S112, the control unit 15 supplies power to the power feeding coil 13 to set the power feeding coil 13 to the charging state. In addition, in order to notify the user that the power feeding coil 13 is in the charging state, the control unit 15 illuminates the indicator 20 orange, as part of the process of S112. Furthermore, the control unit 15 resets the value of the counter C to 0, which is an initial value, as part of the process of S112. Thereafter, the process returns to S104.

The present embodiment as described above has the following advantages.
(1) With the above-described vehicular contactless charging device 11, when noise is introduced into the radio broadcasting during charging of the device to be charged 12, the user initiates a change in the frequency of the power to be supplied to the power feeding coil 13 in the following manner. The user moves the device to be charged 12 away from the power feeding coil 13 and then brings it back toward the power feeding coil 13. Accordingly, the control unit 15 switches the power feeding coil 13 from the standby state to the charging state after switching the power feeding coil 13 from the charging state to the standby state. When such a state change of the power feeding coil 13 occurs, in other words, when the user moves the device to be charged 12 so as to cause the state change to occur, the frequency of the power to be supplied to the power feeding coil 13 is changed. Therefore, it is not necessary to provide an operation unit such as a switch for changing the frequency in the vehicular contactless charging device 11. Consequently, the vehicular contactless charging device 11 is prevented from becoming larger or from requiring an increased number of components due to the addition of such an operation unit.
(2) The frequency of the power to be supplied to the power feeding coil 13 is changed as follows. When the frequency of the power to be supplied to the power feeding coil 13 is the first frequency f1, the frequency is switched to the second frequency f2. When the frequency of the power to be supplied to the power feeding coil 13 is the second frequency f2, the frequency is switched to the first frequency f1. In this manner, since the frequency of the power to be supplied to the power feeding coil 13 is only changed between the first frequency f1 and the second frequency f2, it is easy to change the frequency.
(3) The user can initiate a change in the frequency of the power to be supplied to the power feeding coil 13 by moving the device to be charged 12 away from and toward the power feeding coil 13 such that the elapsed time t falls within the time range described above. On the other hand, if the user moves the device to be charged 12 away from and toward the power feeding coil 13 without the intent of initiating a frequency change, the elapsed time t falls outside the time range described above. As a result, the frequency change does not occur. Accordingly, unnecessary changes in the frequency are prevented.
(4) Since the time range is set to 0.5 seconds to 5 seconds, inclusive, the elapsed time t does not reach the time range in a case in which the device to be charged 12 being charged is deviated from the position enabling charging due to vibration of the vehicle or returns to the position enabling charging thereafter. Therefore, under the above-described situation, it is possible to prevent the frequency of the power to be supplied to the power feeding coil 13 from being erroneously changed. In addition, there may be a case in which the user separates the device to be charged 12 from the power feeding coil 13 thereby interrupting charging, and then brings the device to be charged 12 close to the power feeding coil 13 again for charging after using the device to be charged 12. Also in this case, since the time range is set to 0.5 seconds to 5 seconds, inclusive, it is possible to prevent the frequency of the power to be supplied to the power feeding coil 13 from being erroneously changed.
(5) When the control unit 15 switches the power feeding coil 13 from the charging state to the standby state, the indicator 20 notifies the user of the switching. Specifically, the indicator 20 blinks green to notify the user that the power feeding coil 13 has been switched from the charging state to the standby state. Thus, it is possible to prompt the user to bring the device to be charged 12 closer to the power feeding coil 13 again in order to change the frequency of the power to be supplied to the device to be charged 12.

The above-described embodiment may be modified as follows. The above-described embodiment and the following modifications can be combined as long as the combined modifications remain technically consistent with each other.

Although the indicator 20 that performs visual notification is provided as the notification unit, a buzzer or a speaker that is a notification unit that performs auditory notification may be provided instead of the indicator 20 or in addition to the indicator 20.

The detection unit 19 may be omitted by providing the control unit 15 with the feature of the detection unit 19.

The time range can be changed as appropriate. For example, the time range may be 0.5 seconds to 3 seconds, inclusive.

The first frequency f1 may be a frequency other than 127.7 kHz.

The second frequency f2 may be a frequency other than 120.5 kHz.

Although the frequency of the power to be supplied to the power feeding coil 13 is changed between the first frequency f1 and the second frequency f2, the frequency of the electric power may be changed among three or more frequencies.

The device to be charged 12 is not limited to a smartphone, and may be any other type of device.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuitry are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A vehicular contactless charging device, comprising:
a power feeding coil; and
circuitry configured to supply power to the power feeding coil, and to stop the supply of power to the power feeding coil, wherein
the vehicular contactless charging device is configured such that, when a device to be charged is brought close to the power feeding coil to reach a position enabling charging, a voltage is induced in a power receiving coil of the device to be charged through the supply of power to the power feeding coil by the circuitry, so that the device to be charged receives power from the power receiving coil and is charged, and
the circuitry is configured to
supply power to the power feeding coil to set the power feeding coil to a charging state when the device to be charged is brought close to the power feeding coil to reach the position enabling charging,
stop the supply of power to the power feeding coil to set the power feeding coil to a standby state when the device to be charged moves away from the power feeding coil to be separated from the position enabling charging, and
change a frequency of the power to be supplied to the power feeding coil when switching the power feeding coil from the standby state to the charging state after switching the power feeding coil from the charging state to the standby state.

2. The vehicular contactless charging device according to claim 1, wherein
the circuitry is configured to switch the frequency of the power to be supplied to the power feeding coil between a first frequency and a second frequency, and
when switching the power feeding coil from the standby state to the charging state after switching the power feeding coil from the charging state to the standby state, the circuitry
switches the frequency of the power to be supplied to the power feeding coil to the second frequency if the frequency of the power to be supplied to the power feeding coil is the first frequency, and
switches the frequency of the power to be supplied to the power feeding coil to the first frequency if the frequency of the power to be supplied to the power feeding coil is the second frequency.

3. The vehicular contactless charging device according to claim 1, wherein the circuitry is configured to
measure an elapsed time from a point in time at which the power feeding coil is switched from the charging state to the standby state to a point in time at which the power feeding coil is switched again to the charging state, and
change the frequency of the power to be supplied to the power feeding coil only when the elapsed time is within a predetermined time range.

4. The vehicular contactless charging device according to claim 3, wherein the time range is 0.5 seconds to 5 seconds, inclusive.

5. The vehicular contactless charging device according to claim 1, further comprising a notification unit, wherein the notification is configured to, when the circuitry has switched the power feeding coil from the charging state to the standby state, notify a user of the switching.
